(19) United States
(12) Patent Application Publication
(10) Pub. No.: US 2025/0114994 A1
(43) Pub. Date: Apr. 10, 2025

(54) HIGH STRENGTH AND TOUGHNESS BIAXIALLY-ORIENTED POLYLACTIC ACID (BOPLA) FILM AND PREPARATION METHOD THEREOF

(71) Applicant: Northern Technologies International Corporation, Circle Pines, MN (US)

(72) Inventors: Anthony Charles Keyes, Shoreview, MN (US); Shilpa Durgesh Manjure, Woodbury, MN (US); Alexander Ryan Ermlich, Circle Pines, MN (US); Nagaraj Kuppusamy, Tamil Nadu (IN)

(21) Appl. No.: 18/906,829

(22) Filed: Oct. 4, 2024

Related U.S. Application Data
(60) Provisional application No. 63/588,022, filed on Oct. 5, 2023.

(51) Int. Cl. B29C 48/00; B29C 48/08; B29C 48/21; B29C 48/88; B29K 67/00; B29K 105/00; B29L 31/00; B32B 27/08; B32B 27/36; C08G 63/60; C08G 77/445; C08J 5/18

(52) U.S. Cl. CPC B29C 48/0018; B29C 48/022; B29C 48/08; B29C 48/914; B32B 27/08; B32B 27/36; C08G 63/60; C08G 77/445; C08J 5/18; B29C 48/21; B29K 2067/00; B29K 2067/046; B29K 2105/0014; B29K 2995/0053; B29K 2995/006; B29K 2995/0077; B29K 2995/0089; B29L 2031/712; B32B 2270/00; B32B 2307/516; B32B 2307/518; B32B 2307/54; B32B 2307/558; C08G 2230/00; C08J 2367/04; C08J 2383/10

(57) ABSTRACT

A high strength and biodegradable polymer film comprising a blend of a polylactic acid (PLA) copolymer, a flexible polymer linker, and optionally a compostable polyester segment is disclosed. Upon biaxially stretching, the disclosed polymer film exhibits unexpectedly high tensile strengths and high impact strengths while providing high flexibility as measured according to various standards such as ASTM D882, D3420, and D1709. The disclosed films are formulated to meet common industrial composting standards as defined by ASTM D6400, EN 13432, and ISO 17088, as well as exhibit accelerated biodegradation rates at lower temperatures for home composting applications.

### CROSS-REFERENCE TO RELATED APPLICATIONS

This application claims the benefit of priority to U.S. Provisional Patent Appl. No. 63/588,022 filed Oct. 5, 2023, the disclosure of which is hereby incorporate by reference in its entirety.

### FIELD

The present disclosure relates to biaxially oriented polylactic acid (BOPLA) films with novel formulations that exhibit an unexpectedly high tensile and impact strength, tunable modulus, as well as accelerated biodegradation rates. This film can be used for packaging applications.

### BACKGROUND

The use of biaxially oriented polymers, such as polypropylene (BOPP) and biaxially oriented polyethylene terephthalate (BOPET) films are found in packaging, decorative, and label applications, which can perform multiple functions. Currently, the need to replace carbon-carbon backbone polymers such as polyethylene (PE), polyethylene terephthalate (PET), and polypropylene (PP) with more sustainable polymers is developing worldwide. To reach this goal of sustainability, alternative materials such as biologically derived polymers as well as compostable plastics have been sought after to replace their recalcitrant and petroleum-based materials. Such biobased polymer includes polylactic acid (PLA), which can be derived from corn starch or cane sugar, thus making it a renewable resource.

An advantage of PLA over other biobased materials such as cellulose-based cellophane is that the resin can be easily modified to provide films with greater elastic properties. While biaxially oriented PLA (BOPLA) currently exists in the market, it does not see a wide use due to lower tensile strengths compared to other conventional polymers such as BOPET. Additionally, resins such as PLA meet industrial compostability as defined by standards such as ISO 17088:2021, ASTM D6400, and/or EN 13432, which is not achieved by BOPET and other carbon-carbon backbone polymers. Additionally, there is a market for biodegradable polymer products that are certified for ambient temperature compostable conditions (home composting conditions), based on standards such as AS 5810, NF T 51800, and prEN 17427.

Given the foregoing, there is a need for an improved polymer blend for film formulation that outperforms current biobased alternatives and provides comparable or better mechanical performances to synthetic polymer blends such as BOPET and BOPP, while providing solutions that reach composting at a larger temperature sweep with formulations that meet ambient compost conditions.

### SUMMARY

In one aspect, the disclosed technology relates to a biodegradable polymer film comprising one or more layers, wherein at least one layer is a composition comprising: a polylactic acid (PLA)-block copolymer blend comprising a PLA segment and a flexible polymer segment, wherein the PLA segment comprises about 50 wt % to about 99 wt % PLA, based on the total weight of the PLA-block copolymer blend, wherein the biodegradable polymer film is biaxially stretched, and wherein the biodegradable polymer film exhibits an average Dart impact strength of about 450 g to about 700 g, an average tensile modulus of about 2500 MPa to about 4500 MPa along a machine direction or a transverse direction, and/or an average biodegradation of at least 40% biodegradation within about 75 days at a temperature in a range of about 25° C. to about 30° C.

In some embodiments, the PLA-block copolymer blend is in the form of an A-B-A triblock copolymer, wherein A is the PLA segment and B is the flexible polymer segment. In some embodiments, the PLA-block copolymer blend further comprises a compostable polyester segment. In some embodiments, the PLA-block copolymer blend is an A-B-C triblock copolymer, wherein A is the PLA segment and B is the flexible polymer segment, and C is the compostable polyester segment. In some embodiments, the compostable polyester segment is selected from polybutylene adipate terephthalate (PBAT), polycaprolactone (PCL), polyhydroxy alkanoates (PHAs), polybutylene succinate (PBS), polybutylene succinate adipate (PBSA), polybutylene sebacate (PBSe), and polybutylene sebacate terephthalate (PBSeT). In some embodiments, the PLA-block copolymer blend comprises from about 0 wt % to about 80 wt % compostable polyester segment, based on the total weight of the PLA-block copolymer blend.

In some embodiments, the biodegradable polymer film includes about 0 wt % to about 50 wt % flexible polymer segment, based on the total weight of the PLA-block copolymer blend. In some embodiments, the flexible polymer segment is selected from polybutylene adipate terephthalate (PBAT), polycaprolactone (PCL), polyhydroxy alkanoates (PHAs), polybutylene succinate (PBS), polybutylene succinate adipate (PBSA), polybutylene sebacate (PBSe), polybutylene sebacate terephthalate (PBSeT), polyethylene glycol (PEG), and linear polydimethylsiloxane (PDMS). In some embodiments, the linear polydimethylsiloxane has two ends, each end terminated with a group selected from an amine (NH₂), a hydroxyl (OH), and an epoxide. In some embodiments, the flexible polymer segment has a weight average molecular weight in a range of about 2,000 g/mol to about 600,000 g/mol.

In some embodiments, the biodegradable polymer film comprises a PLA skin layer on a top surface or a bottom surface of the biodegradable polymer film, wherein the PLA skin layer comprises PLA homopolymer. In some embodiments, comprising a PLA skin layer on a top surface and a bottom surface of the biodegradable polymer film, wherein the PLA skin layer comprises PLA homopolymer. In some embodiments, the biodegradable polymer film further comprises a PLA skin layer on a top surface and a bottom surface of the biodegradable polymer film, wherein the PLA skin layer comprises PLA homopolymer. In some embodiments, the PLA skin layer comprises a L-lactide content of about 50 wt % to about 88 wt %, based on the total weight of the PLA homopolymer. In some embodiments, total thickness of the biodegradable polymer film is in a range of about 10 μm to about 100 μm.

In some embodiments, at least one layer of the biodegradable polymer film is a core layer and the biodegradable polymer film further comprises: a PLA skin layer positioned on a top surface of the core layer, wherein the PLA skin layer comprises PLA homopolymer, and the PLA skin layer comprises about 50 wt % to about 88 wt % L-lactide content, based on the total weight of the PLA homopolymer, wherein the PLA homopolymer has a weight average molecular weight in a range of about 100,000 g/mol to about 200,000 g/mol. In some embodiments, the PLA skin layer is a first PLA skin layer comprising a first PLA homopolymer, and the biodegradable polymer film further comprises a second PLA skin layer positioned on a bottom surface of the core layer; wherein the second PLA skin layer comprises a second PLA homopolymer, and the second PLA skin layer comprises about 50 wt % to about 88 wt % L-Lactide content, based on the total weight of the second PLA homopolymer, and wherein the second PLA homopolymer has a weight average molecular weight in a range of about 100,000 g/mol to about 200,000 g/mol.

In one aspect, the disclosed technology relates to an article produced from the biodegradable polymer film disclosed in this document.

In another aspect, the disclosed technology relates to a method of producing a biodegradable polymer film, comprising the steps of: (a) melt extruding a PLA polymer and a flexible linker in the presence of a catalyst to produce a PLA-block copolymer composition comprising about 1 wt % to about 49 wt % flexible linker, based on the total weight of the PLA-block copolymer composition; (b) quenching the PLA-block copolymer composition on a chilled roller; and (c) stretching the PLA-block copolymer composition along a machine direction (MD) and a transverse direction (TD) to produce the biodegradable polymer film; wherein the biodegradable polymer film has an average Dart impact strength of about 450 g to about 700 g, an average tensile modulus of about 2500 MPa to about 4500 MPa along a machine direction or a transverse direction, and/or an average compostability of at least 40% biodegradation within about 75 days under composting conditions at a temperature in a range of about 25° C. to about 30° C.

In some embodiments, step (a) is carried out at a temperature in a range of about 170° C. to about 220° C. In some embodiments, the catalyst comprises tin octanoate and step (a) further comprises adding about 0.01 wt % to about 0.5 wt % of tin octanoate catalyst, based on the total weight of the PLA-block copolymer composition. In some embodiments, step (b) is carried out at a temperature in a range of about −20° C. to about 30° C.

In some embodiments, the stretching along the machine direction in step (c) is carried out at a temperature in a range of about 40° C. to about 65° C. In some embodiments, the stretching along the transverse direction in step (c) is carried out at a temperature in a range of about 85° C. to about 105° C. In some embodiments, the PLA-block copolymer composition is stretched along the machine direction at a machine orientation ratio of about 2.0× to about 4.0×. wherein the PLA-block copolymer composition is stretched along the transverse direction at a transverse orientation ratio of about 2.0× to about 5.0×. In some embodiments, step (a) further comprises adding about 1 wt % to about 80 wt % compostable polyester, based on the total weight of the PLA-block copolymer composition.

### BRIEF DESCRIPTION OF THE DRAWINGS

FIG. 1 depicts an exemplary synthesis of polylactic acid (PLA)-copolymer using a transesterification reaction between PLA and amine-terminated polydimethylsiloxane (NHPDMS).

FIG. 2A depicts a general structure for an ABA triblock copolymer of the present disclosure.

FIG. 2B depicts a general structure for an ABC triblock copolymer of the present disclosure.

FIG. 3A depicts a multilayer biaxially oriented polylactic acid (BOPLA) of the present disclosure with a core polymer layer with a top skin polymer layer.

FIG. 3B depicts another multilayer (trilayer) biaxially oriented polylactic acid (BOPLA) of the present disclosure with a core polymer layer positioned between two skin polymer layers.

FIG. 4 shows room temperature biodegradable data (˜28° C.) comparing cellulose (a natural polymer), commercially available polymer resin, and polymer blend of the present disclosure.

### DETAILED DESCRIPTION

The following discussion omits or only briefly describes conventional features of the disclosed technology that are apparent to those skilled in the art. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to make and use the disclosed technology, in combination with routine experiments, to achieve other outcomes not specifically disclosed in the examples or the embodiments.

Unless otherwise specifically defined herein, all terms are to be given their broadest possible interpretation, including meanings implied from the specification as well as meanings understood by those skilled in the art and/or as defined in dictionaries, treatises, etc. unless defined otherwise, all technical and scientific terms used herein have the same meaning as commonly understood by one of ordinary skill in the art in the field of the disclosed technology. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

As used herein, “about” when used in connection with a numeric value, is intended to include values that are close to, but not exactly, the number to the nearest significant figure. For example, a numerical value of “about 5” may include values ranging from 4.6 to 5.4.

Described within are single-layer and multi-layer biaxially oriented polylactic acid (BOPLA) films that include novel formulations which exhibit improved strength, particularly for tensile and impact properties. This improved tensile and impact strength formulation requires a transesterification/chain-end reactive process in the twin-screw extruder to produce linear block copolymer architectures of disparate polyesters which maintain biodegradability and compostability under industrial conditions, with some formulations meeting ambient temperature compostability.

### Biaxially Oriented Polylactic Acid (BOPLA) Film

A high-strength, biodegradable biaxially oriented polylactic acid polymer film comprising one or more layers, wherein at least one layer is a composition comprising PLA-block copolymer blend is disclosed. In some embodiments, BOPLA film may be a single layer film prepared from a polymer composition comprising a PLA-block copolymer blend. In some embodiments, the PLA-block copolymer blend may comprise a PLA segment covalently bonded to a flexible polymer segment. In some embodiments, the PLA segment may comprise a crystalline PLA homopolymer. Suitable examples of crystalline PLA homopolymer may include but are not limited to PLA resins from NatureWorks® Ingeo™ 2003D, 4032D, or 2500HP, Total Energies Corbion® Luminy™ L175, L130, or LX-175. In some embodiments, PLA resins may have a glass transition temperature from about 50° C. to about 60° C., crystallization temperatures of about 100° C. to about 125° C., melting temperature from about 155° C. to about 180° C., and a density of about 1.24 g/cm³. In some embodiments, single layer BOPLA film may have a total thickness ranging from about 10 μm to about 200 μm, about 10 μm to about 150 μm, about 10 μm to about 100 μm, about 10 μm to about 75 μm, about 10 μm to about 50 μm, about 50 μm to about 200 μm, about 75 μm to about 200 μm, about 100 μm to about 200 μm, or about 150 μm to about 200 μm.

In some embodiments, the PLA-block copolymer blend comprises crystalline PLA polymer or homopolymer in an amount of at least 50 wt %, at least 80 wt %, at least 95 wt %, at least 99 wt % PLA, based on the total weight of the PLA-block copolymer blend. In some embodiments, the PLA polymer or homopolymer content is about 50 wt % to about 99 wt %, about 50 wt % to about 95 wt %, about 50 wt % to about 90 wt %, about 50 wt % to about 85 wt %, about 50 wt % to about 80 wt %, about 55 wt % to about 99 wt %, about 60 wt % to about 99 wt %, about 65 wt % to about 99 wt %, about 70 wt % to about 99 wt %, about 55 wt % to about 95 wt %, about 60 wt % to about 95 wt %, about 65 wt % to about 95 wt %, about 70 wt % to about 95 wt %, based on the total weight of the PLA-block copolymer blend.

In some embodiments, the crystalline PLA homopolymer comprises about 88 wt % to about 100 wt % L-lactide content (i.e., about 0 wt % to about 12 wt % D-lactide content), about 88 wt % to about 98 wt %, about 88 wt % to about 96 wt %, about 88 wt % to about 94 wt %, about 90 wt % to about 100 wt %, about 92 wt % to about 100 wt %, or about 94 wt % to about 100 wt % L-lactide content, based on the total weight of the PLA homopolymer. In some embodiments, the crystalline PLA homopolymer comprises less than or equal to about 12 wt %, less than or equal to about 10 wt %, less than or equal to about 8 wt % or less, less than or equal to about 6 wt %, less than or equal to about 4 wt %, or less than or equal to about 2 wt % D-lactide content, based on the total weight of the PLA homopolymer.

In some embodiments, weight average molecular weight of crystalline PLA polymer in the PLA segment may be from about 100,000 g/mol to about 200,000 g/mol, about 125,000 g/mol to about 200,000 g/mol, about 150,000 g/mol to about 200,000 g/mol, about 175,000 g/mol to about 200,000 g/mol, about 100,000 g/mol to about 175,000, about 100,000 g/mol to about 150,000 g/mol, about 100,000 g/mol to about 125,000 g/mol, or about 120,000 g/mol to about 180,000 g/mol.

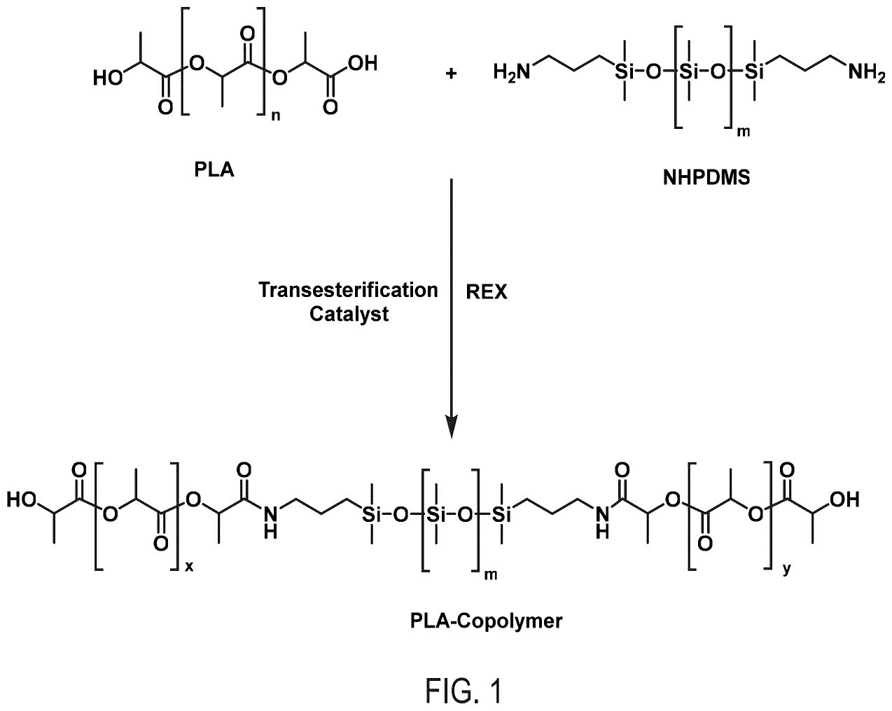

In some embodiments, PLA-block copolymer blend may comprise a flexible polymer segment covalently bonded to or polymerized with the PLA segment. In some embodiments, the PLA segment(s) and the flexible polymer segment may be covalently bonded through a transesterification reaction using a tin octanoate (Sn(Oct)₂) catalyst produced through a reactive extrusion (REX) technique. In some embodiments, (Sn(Oct)₂) may be present in an amount from about 0.01 wt % to about 1 wt %, about 0.1 wt % to about 1 wt %, about 0.25 wt % to about 1 wt %, about 0.5 wt % to about 1 wt %, about 0.75 wt % to about 1 wt %, about 0.01 wt % to about 0.75 wt %, about 0.01 wt % to about 0.5 wt %, about 0.01 wt % to about 0.25 wt %, about 0.01 wt % to about 0.1 wt %, based on the total weight of the PLA-block copolymer blend. Further details regarding catalytic transesterification of PLA with another polymer are illustrated and described, for example in U.S. Pat. No. 11,485,852 to Giri et al., the entire contents of which are incorporated herein by reference. For example, as seen in FIG. 1, a transesterification reaction between an amine-terminated polydimethylsiloxane (NHPDMS) and two PLA homopolymer units producing a PLA-copolymer is shown. In this reaction, the siloxane (Si-O-Si) backbone of NHPDMS provides a flexible segment and the terminal amine (NH₂) groups breaking the ester bonds of the PLA, forming new amide linkage and producing a PLA-NHPDMS-PLA copolymer configuration.

In some embodiments, the flexible polymer segment includes polybutylene adipate terephthalate (PBAT), polycaprolactone (PCL), polyhydroxy alkanoates (PHAs), polybutylene succinate (PBS), polybutylene succinate adipate (PBSA), polybutylene sebacate (PBSe), polybutylene sebacate terephthalate (PBSeT), polyethylene glycol (PEG), or linear polydimethylsiloxane (PDMS).

In some embodiments, the flexible polymer segment is present in the PLA-block copolymer blend in an amount of less than about 50 wt %, based on the total weight of the PLA-block copolymer blend. In some embodiments, the flexible polymer may be present in an amount of about 0.5 wt % to about 50 wt %, about 0.5 wt % to about 30 wt %, about 0.5 wt % to about 20 wt %, about 0.5 wt % to about 10 wt %, about 0.5 wt % to about to about 5 wt %, about 1 wt % to about 50 wt %, about 5 wt % to about 50 wt %, about 10 wt % to about 50 wt %, about 20 wt % to about 50 wt %, about 30 wt % to about 50 wt %, about 40 wt % to about 50 wt %, less than or equal to about 50 wt %, less than or equal to about 40 wt %, less than or equal to about 30 wt %, less than or equal to about 20 wt %, less than or equal to about 10 wt %, less than or equal to about 5 wt %, or less than or equal to about 1 wt %, based on the total weight of the PLA-block copolymer blend.

In some embodiments, the weight average molecular weights of the flexible polymer segments may range from about 2,000 g/mol to about 600,000 g/mol, about 2,000 g/mol to about 10,000 g/mol, about 2,000 g/mol to about 50,000 g/mol, about 2,000 g/mol to about 100,000 g/mol, about 2,000 g/mol to about 500,000 g/mol, about 2,000 g/mol to about 250,000 g/mol, about 2,000 g/mol to about 100,000 g/mol, about 5000 g/mol to about 600,000 g/mol, about 100,000 g/mol to about 600,000 g/mol, about 250,000 g/mol to about 600,000 g/mol, about 500,000 g/mol to about 600,000 g/mol.

In some embodiments, PLA-block copolymer blend may comprise a compostable polyester segment comprising a compostable polymer covalently bonded to or polymerized with the PLA segment and/or the flexible segment. In some embodiments, the compostable polyester segment may be bonded to PLA segment and the flexible polymer segment through a transesterification reaction using a tin octanoate (Sn(Oct)₂) catalyst produced through a reactive extrusion (REX) technique. In some embodiments, the compostable polyester segment may be selected from the group consisting of polybutylene adipate terephthalate (PBAT), polycaprolactone (PCL), polyhydroxy alkanoates (PHAs), polybutylene succinate (PBS), polybutylene succinate adipate (PBSA), polybutylene sebacate (PBSe), polybutylene sebacate terephthalate (PBSeT), and a combination thereof. In some embodiments, the compostable polyester segment may be the same polymer as the flexible segment.

In some embodiments, PLA-block copolymer blend may comprise a compostable polyester segment in an amount ranging from about greater than 0 wt % to less than about 50 wt %, based on the total weight of the PLA-block copolymer blend. In some embodiments, the compostable polyester may be present in an amount ranging from about 0 wt % to about 80 wt %, about 1 wt % to about 80 wt %, about 5 wt % to about 80 wt %, about 25 wt % to about 80 wt %, about 50 wt % to about 80 wt %, about 1 wt % to about 60 wt %, about 1 wt % to about 40 wt %, about 1 wt % to about 20 wt %, or about 20 wt % to about 30 wt %, based on the total weight of the PLA-block copolymer blend. In some embodiments, the weight average molecular weights of the compostable polyester segment may range from about 100,000 g/mol to about 600,000 g/mol, about 200,000 g/mol to about 600,000 g/mol, about 400,000 g/mol to about 600,000 g/mol, about 100,000 g/mol to about 500,000 g/mol, or about 100,000 g/mol to about 300,000 g/mol.

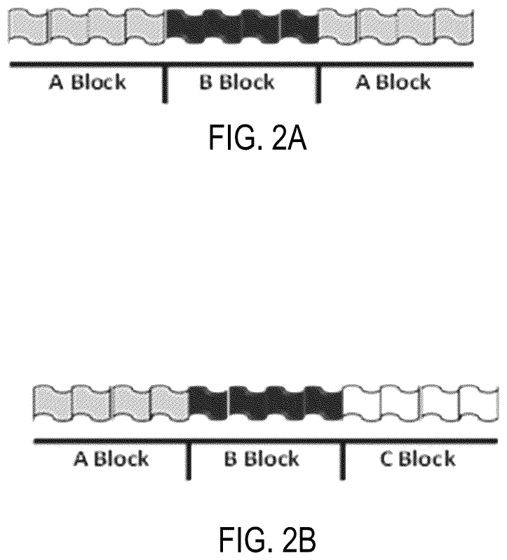

In some embodiments, PLA-block copolymer blend may be a triblock copolymer. As used herein “triblock copolymer” may refer to a copolymer structure in which the basic, repeating segment or unit consisting of three polymeric block chains. The three polymers may be different or may be repeating. As seen in FIG. 2A, in some embodiments, PLA-block copolymer of the present disclosure may be in an A-B-A triblock configuration, wherein A and B represent distinct polymeric segments. In some embodiments, A segment may be the PLA segment and B may be the flexible polymer segment as disclosed above in FIG. 2A and exemplified in PLA-Copolymer of FIG. 1.

As seen in FIG. 2B, PLA-block copolymer blend of the present disclosure may be an A-B-C triblock configuration, wherein A represents the PLA segment, B represents the flexible polymer segment, and C represents a compostable polyester segment. In some embodiments, the compostable polyester segment may be selected from the group consisting of polybutylene adipate terephthalate (PBAT), polycaprolactone (PCL), polyhydroxy alkanoates (PHAs), polybutylene succinate (PBS), polybutylene succinate adipate (PBSA), polybutylene sebacate (PBSe), polybutylene sebacate terephthalate (PBSeT), and a combination thereof. In some embodiments, the compostable polyester segment may be the same polymer as the flexible segment, i.e., B and C components may be the same polymer. In some embodiments, the PLA-block copolymer blend may comprise the compostable polyester group in an amount ranging from about 0 wt % to about 80 wt %, about 1 wt % to about 80 wt %, about 5 wt % to about 80 wt %, about 25 wt % to about 80 wt %, about 50 wt % to about 80 wt %, about 1 wt % to about 60 wt %, about 1 wt % to about 40 wt %, about 1 wt % to about 20 wt %, or about 20 wt % to about 30 wt %, based on the total weight of the PLA-block copolymer blend.

In some embodiments, PLA-block copolymer blend may optionally comprise an epoxy-based copolymer in an amount less than or equal to about 1.0 wt %, less than or equal to about 0.9 wt %, less than or equal to about 0.8 wt %, less than or equal to about 0.7 wt %, less than or equal to about 0.6 wt %, less than or equal to about 0.5 wt %, less than or equal to about 0.4 wt %, less than or equal to about 0.3 wt %, less than or equal to about 0.2 wt %, less than or equal to about 0.1 wt %, or from about 0.1 wt % to about 1.0 wt %, about 0.1 wt % to about 0.75 wt %, about 0.1 wt % to about 0.5 wt %, about 0.1 wt % to about 0.25 wt %, about 0.25 wt % to about 1.0 wt %, about 0.5 wt % to about 1 wt %, or about 0.75 wt % to about 1 wt %, based on the total weight of the PLA-block copolymer blend. In some embodiments, the epoxy-based copolymer may include, but are not limited to styrene-acrylate-epoxy, methacrylic-epoxy, or a combination thereof. These epoxy-based polymers act as a chain branching agent and further stabilizes the BOPLA film. Suitable examples of epoxy-based polymers that may be used as a branching agent may include but are not limited to Joncryl™ 4468 and Joncryl™ 4438 and Kane Ace MB-21.

In some embodiments, PLA-block copolymer blend may optionally comprise a maleic anhydride-based copolymer in an amount less than or equal to about 1.0 wt %, less than or equal to about 0.9 wt %, less than or equal to about 0.8 wt %, less than or equal to about 0.7 wt %, less than or equal to about 0.6 wt %, less than or equal to about 0.5 wt %, less than or equal to about 0.4 wt %, less than or equal to about 0.3 wt %, less than or equal to about 0.2 wt %, less than or equal to about 0.1 wt %, or from about 0.1 wt % to about 1.0 wt %, about 0.1 wt % to about 0.75 wt %, about 0.1 wt % to about 0.5 wt %, about 0.1 wt % to about 0.25 wt %, about 0.25 wt % to about 1.0 wt %, about 0.5 wt % to about 1 wt %, or about 0.75 wt % to about 1 wt %, based on the total weight of the PLA-block copolymer blend. In some embodiments, the epoxy-based copolymer may include, but are not limited to styrene-acrylate-epoxy, methacrylic-epoxy, or a combination thereof. These epoxy-based polymers act as a chain branching agent and further stabilizes the BOPLA film. Suitable examples of epoxy-based polymers that may be used as a branching agent may include but are not limited to Joncryl™ 4468 and Joncryl™ 4438 and Kane Ace MB-21.

In some embodiments, PLA-block copolymer blend may optionally comprise additives such as fatty acid slip agents in an amount less than or equal to about 1.0 wt %, less than or equal to about 0.9 wt %, less than or equal to about 0.8 wt %, less than or equal to about 0.7 wt %, less than or equal to about 0.6 wt %, less than or equal to about 0.5 wt %, less than or equal to about 0.4 wt %, less than or equal to about 0.3 wt %, less than or equal to about 0.2 wt %, less than or equal to about 0.1 wt %, or from about 0.1 wt % to about 1.0 wt %, about 0.1 wt % to about 0.75 wt %, about 0.1 wt % to about 0.5 wt %, about 0.1 wt % to about 0.25 wt %, about 0.25 wt % to about 1.0 wt %, about 0.5 wt % to about 1 wt %, or about 0.75 wt % to about 1 wt %, based on the total weight of the PLA-block copolymer blend. In some embodiments, fatty acid slip agents may include, but are not limited to erucamide, behenamide, oleamide, ethylene bis stearamide, or a combination thereof. In some embodiments, PLA-block copolymer blend may optionally comprise inorganic antiblock particles in an amount ranging from about 0.1 wt % to about 20 wt %, about 0.1 wt % to about 15 wt %, about 0.1 wt % to about 10 wt %, about 0.1 wt % to about 5 wt %, about 0.1 wt % to about 1 wt %, about 1 wt % to about 20 wt %, about 5 wt % to about 20 wt %, about 10 wt % to about 20 wt %, about 15 wt % to about 20 wt %, based on the total weight of the PLA-block copolymer blend. In some embodiments, the inorganic antiblock particles may have a particle size (in diameter, or longest distance between edges of the particle if not uniformly spherical) ranging from about 1 μm to about 10 μm, about 2.5 μm to about 10 μm, about 5 μm to about 10 μm, about 7.5 μm to about 10 μm, about 1 μm to about 7.5 μm, about 1 μm to about 5 μm. about 1 μm to about 2.5 μm. In some embodiments, inorganic antiblock particles may include, but are not limited to silica-based particles including modified silica.

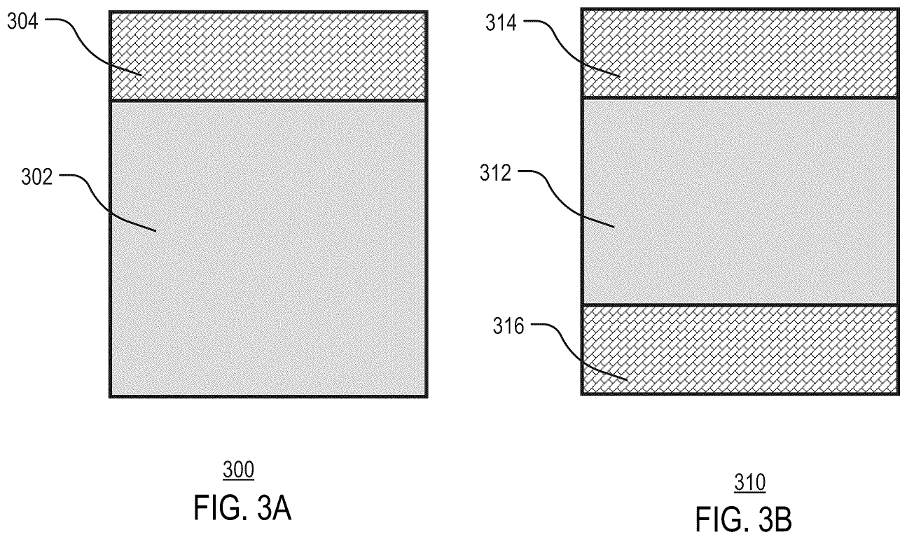

Now referring to FIGS. 3A and 3B, two different configurations of multilayer biaxially oriented polylactic acid film are disclosed herein. In some embodiments, as seen in FIGS. 3A, a multilayer BOPLA film 300 may comprise a core or a base layer 302 comprising the single layer PLA-block copolymer blend as disclosed above. It should be understood that BOPLA film 300 may comprise the same, similar, and/or substantially the same components, features, and functionality, as well as be fabricated using the similar and/or substantially the same method as single layer BOPLA film disclosed above. In some embodiments, multilayer BOPLA film 300 may comprise an outer skin layer 304. In some embodiments, skin layer 304 may comprise a PLA homopolymer resin having a D-lactide content is higher than that of D-lactide content in present in core layer 302. In some embodiments, the PLA homopolymer resin present in skin layer 304 may comprise about 50 wt % to about 100 wt % L-lactide content (i.e. about 0 wt % to about 50 wt % D-lactide content), based on the total weight of the PLA homopolymer resin. In some embodiments, the PLA homopolymer resin present in skin layer 304 has an L-lactide content of: about 50 wt % to about 88 wt % (i.e., about 12 wt % to about 50 wt % D-lactide content), about 50 wt % to about 85 wt %, about 50 wt % to about 80 wt %, about 55 wt % to about 85 wt %, or about 55 wt % to about 80 wt %, based on the total weight of the PLA homopolymer resin.

In some embodiments, the PLA homopolymer resin present in skin layer 304 may comprise about 88 wt % to about 100 wt % L-lactide content (i.e. about 0 wt % to about 12 wt % D-lactide content), about 90 wt % to about 100 wt %, about, about 95 wt % to about 100 wt %, about 88 wt % to about 95 wt % L-lactide content, based on the total weight of the PLA homopolymer resin. In some embodiments, the PLA homopolymer resin present in skin layer 304 has a D-lactide content of less than or equal to about 50 wt %, less than or equal to about 45 wt %, less than or equal to about 40 wt %, less than or equal to about 35 wt %, less than or equal to about 30 wt %, less than or equal to about 25 wt %, less than or equal to about 20 wt %, or less than or equal to about 12 wt % (i.e., L-lactide content of greater than or equal to about 50 wt %, greater than or equal to about 55 wt %, greater than or equal to about 60 wt %, greater than or equal to about 65 wt %, greater than or equal to about 70 wt %, greater than or equal to about 75 wt %, greater than or equal to about 80 wt %, greater than or equal to about 85 wt %, or greater than or equal to about 88 wt %, respectively), based on the total weight of the PLA homopolymer resin. In some embodiments, the PLA homopolymer resin present in skin layer 304 may comprise about D-lactide content of less than or equal to about 12 wt %, less than or equal to about 10 wt %, less than or equal to about 8 wt %, less than or equal to about 6 wt %, less than or equal to about 4 wt %, or less than or equal to about 2 wt % (i.e., L-lactide content of greater than or equal to about 88 wt %, greater than or equal to about 90 wt %, greater than or equal to about 92 wt %, greater than or equal to about 94 wt %, greater than or equal to about 96 wt %, or greater than or equal to about 98 wt %), based on the total weight of the PLA homopolymer resin.

In some embodiments, weight average molecular weight of PLA polymer in homopolymer resin may be from about 100,000 g/mol to about 200,000 g/mol, about 125,000 g/mol to about 200,000 g/mol, about 150,000 g/mol to about 200,000 g/mol, about 175,000 g/mol to about 200,000 g/mol, about 100,000 g/mol to about 175,000, about 100,000 g/mol to about 150,000 g/mol, about 100,000 g/mol to about 125,000 g/mol, or about 120,000 g/mol to about 180,000 g/mol. In some embodiments, the PLA resins in skin layer 304 may have a glass transition temperature from about 40° C. to about 55° C., no melting temperature, about 88 wt % L-lactide content (i.e., about 12 wt % D-lactide content), based on the total weight of the PLA resin, and a density of about 1.24 g/cm³. Suitable examples of PLA homopolymer resins that may be used in the skin layer include but are not limited to PLA resins from NatureWorks® Ingeo™ 4060D, 4950D, and Total Energies Corbion® Luminy™ LX-975.

In some embodiments, skin layer 304 may be blended with inorganic antiblock particles or fatty acid slip agents in the biaxial orientation process to provide improved processability and handling. In some embodiments, skin layer 304 may be blended with optional epoxy-based copolymer, such as styrene-acrylate-epoxy copolymer and/or methacrylic-epoxy copolymer, which can provide even better compatibility with the core layer. Suitable examples of epoxy-based polymers may include but are not limited to Joncryl™ 4468 and Joncryl™ 4438, and Kane Ace MB-21. In some embodiments, skin layer 304 may additionally comprise epoxy-based copolymer in an amount less than or equal to about 1.0 wt %, less than or equal to about 0.9 wt %, less than or equal to about 0.8 wt %, less than or equal to about 0.7 wt %, less than or equal to about 0.6 wt %, less than or equal to about 0.5 wt %, less than or equal to about 0.4 wt %, less than or equal to about 0.3 wt %, less than or equal to about 0.2 wt %, less than or equal to about 0.1 wt %, based on the total weight of the skin layer 304.

In some embodiments, skin layer 304 may optionally be blended with additives such as fatty acid slip agents in an amount from about 0.1 wt % to about 1.0 wt %, about 0.1 wt % to about 0.75 wt %, about 0.1 wt % to about 0.5 wt %, about 0.1 wt % to about 0.25 wt %, about 0.25 wt % to about 1 wt %, about 0.5 wt % to about 1 wt %, about 0.75 wt % to about 1 wt %, less than or equal to about 1.0 wt %, less than or equal to about 0.9 wt %, less than or equal to about 0.8 wt %, less than or equal to about 0.7 wt %, less than or equal to about 0.6 wt %, less than or equal to about 0.5 wt %, less than or equal to about 0.4 wt %, less than or equal to about 0.3 wt %, less than or equal to about 0.2 wt %, less than or equal to about 0.1 wt %, based on the total weight of the skin layer. In some embodiments, fatty acid slip agents may include, but are not limited to erucamide, behenamide, oleamide, ethylene bis stearamide, or a combination thereof. In some embodiments, the PLA-block copolymer may optionally comprise inorganic antiblock particles in an amount ranging from about 0.1 wt % to about 5 wt %, about 0.1 wt % to about 3 wt %, about 0.1 wt % to about 1 wt %, about 1 wt % to about 5 wt %, or about 3 wt % to about 5 wt %, based on the total weight of the skin layer. In some embodiments, the inorganic antiblock particles may have a particle size (in diameter) ranging from about 1 μm to about 10 μm, about 2.5 μm to about 10 μm, about 5 μm to about 10 μm, about 7.5 μm to about 10 μm, about 1 μm to about 7.5 μm, about 1 μm to about 5 μm. about 1 μm to about 2.5 μm. In some embodiments, inorganic antiblock particles may include, but are not limited to silica-based particles including modified silica.

In some embodiments, multilayer BOPLA film 300 may have a total thickness ranging from about 10 μm to about 200 μm, about 10 μm to about 150 μm, about 10 μm to about 100 μm, about 10 μm to about 75 μm, about 10 μm to about 50 μm, about 50 μm to about 200 μm, about 75 μm to about 200 μm, about 100 μm to about 200 μm, about 150 μm to about 200 μm. In some embodiments, skin layer 304 may have a total thickness ranging from about 2 μm to about 25 μm, about 5 μm to about 25 μm, about 10 μm to about 25 μm, about 15 μm to about 25 μm, about 20 μm to about 25 μm, about 2 μm to about 5 μm, about 2 μm to about 10 μm, about 2 μm to about 15 μm, or about 2 μm to about 20 μm. In some embodiments, BOPLA film 300 may further comprise a metal deposited, i.e., surface metallization, on skin layer 304 to further strengthen BOPLA film 300. In some embodiments, the metal such as aluminum may be used for surface metallization. In some embodiments, when the film is a monolayer film, i.e., a single layer BOPLA, or when the core layer 302 and skin layer 304 are the same, top or bottom surface of the respective films may be metallized. In some embodiments, when skin layer 304 or monolayer BOPLA is surface metallized, addition of migratory slip additives should be avoided as they are known to affect metal adhesion in BOPLA films. Accordingly, when surface metallization is utilized, nonmigratory antiblock materials such as silica or modified silica may be used.

In some embodiments, as seen in FIGS. 3B, a multilayer BOPLA film 310 may comprise a core or a base layer 312. It should be understood that BOPLA film 310 may comprise the same, similar, and/or substantially the same components, amounts of components, features, functionality, as well as be fabricated using the similar and/or substantially the same method as single layer BOPLA film 300. It should be understood that parts with similar numbering, i.e., 302 and 312, or 304 and 314, describe the same or substantially the same features. For example, top skin layer 314 may comprise the same, similar, and/or substantially the same components, features, functionality, as well as be fabricated using the similar and/or substantially the same method as skin layer 304. In some embodiments, in addition to top skin layer 314, multiplayer BOPLA film 310 may comprise a second, bottom skin layer 316 comprising the same or substantially the same components as top skin layer 314. In some embodiments, top skin layer 314 and bottom skin layer 316 may be the same, or may vary with respect to the formulation, e.g., type and the amount of PLA and/or additives present in each layer.

In some embodiments, multilayer BOPLA film 310 may have a total thickness ranging from about 10 μm to about 200 μm, about 10 μm to about 150 μm, about 10 μm to about 100 μm, about 10 μm to about 75 μm, about 10 μm to about 50 μm, about 50 μm to about 200 μm, about 75 μm to about 200 μm, about 100 μm to about 200 μm, about 150 μm to about 200 μm. In some embodiments, top skin layer 314 and bottom skin layer 316 may independently have thickness ranging from about 2 μm to about 25 μm, about 5 μm to about 25 μm, about 10 μm to about 25 μm, about 15 μm to about 25 μm, about 20 μm to about 25 μm, about 2 μm to about 5 μm, about 2 μm to about 10 μm, about 2 μm to about 15 μm, or about 2 μm to about 20 μm. In some embodiments, BOPLA film 310 may further comprise a metal deposited on top skin layer 314 or bottom skin layer 316 to further strengthen BOPLA film 310. In some embodiments, the metal such as aluminum may be used for surface metallization. In some embodiments, only one of skin layer 314 or skin layer 316 may be metallized, and the non-metallized layer unmodified for heat sealing.

In some embodiments, the BOPLA film of the present disclosure may exhibit biodegradation for a majority PLA film at a temperature in a range of about 25° C. to about 30° C., about 25° C. to about 28° C., about 28° C. to about 30° C., or at about 25° C., about 26° C., about 27° C., about 28° C., about 29° C., or about 30° C. In some embodiments, the BOPLA film may have an average biodegradation of at least 10% in less than about 7 days, an average biodegradation of at least 20% in less than about 15 days, an average biodegradation of at least 30% in less than about 30 days, under a temperature range of about 28° C. Percent biodegradation was calculated using cellulose as the control sample. Biodegradation tests were run with modified EN13432 standard with temperature set to about 28° C.

In some embodiments, the BOPLA film of the present disclosure may have an average machine direction tensile strength of about 100 MPa to about 200 MPa, about 100 MPa to about 125 MPa, about 100 MPa to about 150 MPa, about 100 MPa to about 175 MPa, about 125 MPa to about 200 MPa, about 150 MPa to about 200 MPa, about 175 MPa to about 200 MPa Machine direction tensile strength is measured according to the method of ASTM 882.

In some embodiments, the BOPLA film of the present disclosure may have an average transverse direction tensile strength of about 100 MPa to about 200 MPa, about 100 MPa to about 125 MPa, about 100 MPa to about 150 MPa, about 100 MPa to about 175 MPa, about 125 MPa to about 200 MPa, about 150 MPa to about 200 MPa, about 175 MPa to about 200 MPa. Transverse direction tensile strength is measured according to the method of ASTM 882.

In some embodiments, the BOPLA film of the present disclosure may have an average Spencer impact strength of about 2000 MJ to about 3000 MJ, about 2000 MJ to about 2750 MJ, about 2000 MJ to about 2500 MJ, about 2000 MJ to about 2250 MJ, about 2250 MJ to about 3000 MJ, about 2500 MJ to about 3000 MJ, about 2750 MJ to about 3000 MJ. Spencer impact strength is measured according to the method of ASTM D3420.

In some embodiments, the BOPLA film of the present disclosure may have an average machine direction elongation of about 20% to about 100%, about 20% to about 80%, about 20% to about 60%, about 20% to about 40%, about 40% to about 100%, about 60% to about 100%, about 80% to about 100% elongation from the initial, unstretched form, without irreversibly deforming from the original structure. In some embodiments, the BOPLA film of the present disclosure may have an average transverse direction elongation of about 20% to about 80%, about 20% to about 60%, about 20% to about 40%, about 40% to about 80%, about 60% to about 80% elongation from the initial, unstretched form, without irreversibly deforming from the original structure. % Elongation is measured according to the method of ASTM D882.

In some embodiments, the BOPLA film of the present disclosure may have an average machine direction tensile modulus of about 2500 MPa to about 4500 MPa, about 2500 MPa to about 4000 MPa, about 2500 MPa to about 3500 MPa, about 2500 MPa to about 3000 MPa, about 3000 MPa to about 4500 MPa, about 3500 MPa to about 4500 MPa or about 4000 MPa to about 4500 MPa. Machine direction tensile modulus is measured according to the method of ASTM 882.

In some embodiments, the BOPLA film of the present disclosure may have an average transverse direction tensile modulus of about 2500 MPa to about 4000 MPa, about 2500 MPa to about 3500 MPa, about 2500 MPa to about 3000 MPa, about 3000 MPa to about 4500 MPa, about 3500 MPa to about 4500 MPa or about 4000 MPa to about 4500 MPa. Transverse direction tensile modulus is measured according to the method of ASTM 882.

In some embodiments, the BOPLA film of the present disclosure may have an average Dart impact strength of about 450 g to about 700 g, about 450 g to about 650 g, about 450 g to about 600 g, about 450 g to about 550 g, about 450 g to about 500 g, about 500 g to about 700 g, about 550 g to about 700 g, about 600 g to about 700 g, about 650 g to about 700 g. Dart impact strength is measured by ASTM D1709.

### Manufacturing Methods

The present disclosure also relates to methods of manufacturing a reactively blended resin prepared for the BOPLA film disclosed above. In some embodiments, manufacturing methods may include compounding the PLA-block copolymer blend in a twin-screw extruder in a reactive extrusion (REX) process. In some embodiments, the raw materials, i.e., PLA polymer, a flexible polymer, and optionally a compostable polyester, are dried to a moisture level below about 1000 ppm, below about 500 ppm, below about 100 ppm, or below about 50 ppm, before compounding in the extruder. The raw materials are then blended in a twin-screw extruder in an REX process in presence of a tin octanoate (Sn(Oct)₂) catalyst under extrusion rate of about 50 rpm and about 400 rpm, about 50 rpm to about 300 rpm, about 50 rpm to about 200 rpm, about 50 rpm to about 100 rpm, about 100 rpm to about 400 rpm, about 200 rpm to about 400 rpm, about 300 rpm to about 400 rpm, about 100 rpm to about 300 rpm, about 200 rpm to about 250 rpm, at a lowest screw profile temperature suitable to melt the raw material and form a PLA-block copolymer blend or composition of the present disclosure in the form of resin. In some embodiments, this process may be carried out at a temperature in a range of about 140° C. to about 220° C., about 140° C. to about 200° C., about 140° C. to about 160° C., about 150° C. to about 220° C., about 170° C. to about 220° C., about 200° C. to about 220° C., about 160° C. to about 200° C., or about 170° C. to about 190° C.

In some embodiments, the BOPLA film is made on a tenter-frame line in a sequential process. The methods described herein are also applicable to related processes such as double bubble and simultaneous biaxial film formation. The raw materials are fed into a hopper and are extruded to make a cast film. In some embodiments, the extrusion process may be carried out at an extrusion rate of about 50 rpm and about 400 rpm, about 50 rpm to about 300 rpm, about 50 rpm to about 200 rpm, about 50 rpm to about 100 rpm, about 100 rpm to about 400 rpm, about 200 rpm to about 400 rpm, about 300 rpm to about 400 rpm, about 100 rpm to about 300 rpm, about 200 rpm to about 250 rpm, and at a temperature range of about 170° C. to about 220° C., about 170° C. to about 200° C., about 200° C. to about 220° C.

The material is then extruded from a die at a given thickness to form the cast film. The molten film is quenched from the die by falling onto chilled rolls. In some embodiment, the cast film or the tube is quenched at a temperature in a range of about −20° C. to about 50° C., about −20° C. to about 30° C., about −20° C. to about 10° C., about −20° C. to about 0° C., about −10° C. to about 50° C., about 0° C. to about 50° C., about 20° C. to about 50° C., or about 30° C. to about 50° C., to allow solidification of the non-oriented film and prevent premature crystallization events before orienting the quenched cast film or tube. In some embodiments, during the quenching process, the tube may be collapse into a flat tube.

In some embodiments, the cast film may then be extruded alone, i.e., single layer, or coextruded with a PLA homopolymer of the present disclosure to provide one or more skin layers positioned on top and bottom surfaces of the cast film, i.e., form a multilayer film. Following quenching on the chilled roll, the cast film maybe subsequently oriented (under orientation heating temperature) in the machine direction (MD) and transverse direction (TD) into a biaxially oriented film. In some embodiments, following quenching in water of a downward blown bubble, the collapsed tube may be re-inflated to stretch the tube in a machine direction (MD) under MD orientation temperature and transverse direction (TD) under TD orientation temperature. In some embodiments, biaxial orientation (TD and MD stretching) may be performed either sequentially or simultaneously.

In some embodiments, the machine direction orientation (MDO) ratio may be from about 2.0× to about 4.0×, about 2.0× to about 3.5×, about 2.0× to about 3.0×, about 2.0× to about 2.5×, about 2.5× to about 4.0×, about 3.0× to about 4.0×, or about 3.5× to about 4.0×. In some embodiments, the transverse direction orientation (TDO) ratio may be from about 2.0× to about 5.0×, about 2.0× to about 4.5×, about 2.0× to about 4.0×, about 2.0× to about 3.5×, about 2.0× to about 3.0×, about 2.0× to about 2.5×, about 2.5× to about 5.0×, about 3.0× to about 5.0×, about 3.5× to about 5.0×, about 4.0× to about 5.0×, or about 4.5× to about 5.0×. As used herein, “orientation ratio,” when referring to machine direction orientation or transverse direction orientation refers to the thickness/width of the finished film to the initial thickness/width at the die. For example, an MDO ratio of 2× means that the film was stretched to afford halve its original thickness when stretched in the machine direction. TDO stretching of 2× would afford two times the original width when stretched in the transverse direction.

In some embodiments, the MDO temperature is in a range of about 40° C. to about 65° C., about 40° C. to about 60° C., about 40° C. to about 55° C., about 40° C. to about 50° C., about 40° C. to about 45° C., about 45° C. to about 65° C., about 50° C. to about 65° C., about 55° C. to about 65° C., or about 60° C. to about 65° C. In some embodiments, the TDO temperature is in a range of about 85° C. to about 105° C., about 85° C. to about 95° C., or about 95° C. to about 105° C.

In some embodiments, after biaxially orienting the films, the biaxially oriented film may be exposed to a heat setting treatment at a temperature range from about 100° C. to about 160° C., about 100° C. to about 140° C., about 100° C. to about 120° C., about 120° C. to about 160° C., about 140° C. to about 160° C., about 115° C. to about 145° C., or about 125° C. to about 135° C., to prevent residual heat-induced shrinkage of the film in both MDO and TDO. In some embodiments, without a heat setting treatment, the biaxially oriented films may exhibit about 50%, about 40%, about 30%, about 20%, or about 10% shrinkage from the initial film. Applying the heat setting treatment reduces the thermal shrinkage effects to less than about 10% shrinkage, less than about 9% shrinkage, less than about 8% shrinkage, less than about 7% shrinkage, less than about 6% shrinkage, less than about 5% shrinkage, less than about 4% shrinkage, less than about 3% shrinkage, less than about 2% shrinkage, or less than about 1% shrinkage. In some embodiments, the biaxially oriented film may be metallized with metals such as aluminum, using a vapor-deposition technique.

In some embodiments, the final thickness of the biaxially oriented film produced from the disclosed method is determined by the cast film or the tube wall thickness as well as the stretch ratios. In some embodiments, the biaxially oriented film may have a total thickness ranging from about 10 μm to about 200 μm, about 10 μm to about 150 μm, about 10 μm to about 100 μm, about 10 μm to about 75 μm, about 10 μm to about 50 μm, about 50 μm to about 200 μm, about 75 μm to about 200 μm, about 100 μm to about 200 μm, about 150 μm to about 200 μm.

In some embodiments, the BOPLA film produced from the disclosed manufacturing method may be used to manufacture BOPLA-based articles, such as a film, container, bottle, bag, or laminate.

Additional advantages of the disclosed technology will become readily apparent to those skilled in the art from the following detailed description, wherein only some embodiments are shown and described. As will be realized, the disclosed technology is capable of other and different embodiments, and its details are capable of modifications in various obvious respects, all without departing from the disclosed technology. Accordingly, the examples and description are to be regarded as illustrative in nature and not as restrictive.

### EXAMPLES

The disclosed technology is next described by means of the following examples. The use of these and other examples anywhere in the specification is illustrative only, and in no way limits the scope and meaning of the invention or of any exemplified form. Likewise, the invention is not limited to any particular preferred embodiments described herein. Indeed, modifications and variations of the invention may be apparent to those skilled in the art upon reading this specification and can be made without departing from its spirit and scope. The invention is therefore to be limited only by the terms of the claims, along with the full scope of equivalents to which the claims are entitled. Efforts have been made to ensure accuracy with respect to values presented (e.g., amounts, temperature, etc.), but some experimental error and deviation should be accounted for. Throughout the present disclosure, unless indicated otherwise, temperature is in degrees Centigrade and is at or near room temperature, pressure is at or near atmospheric, and, and a percentage content of an ingredient is a weight percentage.

For purpose of the present disclosure and the following examples, various parameters (e.g., film thickness, tensile strength, tensile modulus, elongation, Spencer impact strength, and Dart impact strength, composability) are measured using techniques known to those of ordinary skill in the art or as otherwise described below.

Tensile strength: Tensile strength measures the maximum stress that the disclosed polymer films can withstand while being stretch or pulled in machine or transverse direction before breaking. For the purposes of the present disclosure, tensile strength was measured according to testing parameters outlined in ASTM D882.

Tensile modulus: Tensile modulus measures stiffness of the disclosed polymer films when the force is applied in machine or transverse direction. Higher tensile modulus value means that the material is stiffer, i.e., more force is required to irreversibly deform the polymer film. For the purposes of the present disclosure, tensile modulus was according to testing parameters outlined in ASTM D882.

Elongation: Elongation of the disclosed polymer films in machine direction and transverse measures or transverse direction measures the maximum elongation or stretching of the disclosed polymer from an unstretched form, without irreversibly deforming from the original structure. For the purposes of the present disclosure, elongation was measured according to testing parameters outlined in ASTM D882.

Spencer impact strength: Spencer impact strength of the disclosed polymer film measures the maximum energy from an impact, e.g., force from a hammer or a pendulum, that the polymer film can absorb without fracturing or breaking. For the purposes of the present disclosure, Spencer impact strength was measured according to testing parameters outlined in ASTM D3420.

Dart impact strength: Dart impact strength of the disclosed polymer film measures the maximum force from a falling object, e.g., a weighted dart, that the polymer film can withstand a without fracturing or breaking. For the purposes of the present disclosure, Dart impact strength was measured according to testing parameters outlined in ASTM D1709.

Biodegradation: Biodegradation of the disclosed polymer film was measured using AS 5810 standard for plastics suitable for home composting, which allows for a year of testing at ambient temperatures (25° C.+/−5° C.). For the following data included in this patent, a biodegradation temperature of about 28° C. and time frame of about 135 days was captured. For the purposes of the present disclosure, compostability was measured as % biodegradation over a period of time measured in days.

### Example 1: Preparation of PLA-Based Resin Blends

Blends of compostable polymers and flexible linkers were prepared in a LabTech Scientific LTE-26 co-rotating 26 mm twin screw extruder with an L/D ratio of 44:1. Samples were taken from the beginning, middle, and end of each extrusion run and tested for ash and formulation consistency using a muffle furnace and thermogravimetric analyzer (TGA) respectively. Molecular weight was also monitored with gel permeation chromatography (GPC), utilizing polystyrene standards and chloroform as the eluent at 40° C. D-lactide content of PLA polymers was determined from supplier analyses. Alternative methods for D-lactide content determination include ¹H-NMR spectroscopy, gas chromatography followed by high performance liquid chromatography, infrared spectroscopy, as well as polarimetry to measure the D-lactide content.

Blended resin samples produced from Biopolymer Formulations (BFs) 1-3. BF1-BF3 were prepared by blending included PLA having D-lactide content of 4 wt % (P4), and 0.5 wt % (P6) with flexible linkers and including amine-terminated polydimethylsiloxanes (NHPDMS) (L1), polybutylene adipate terephthalate (L3), polybutylene succinate (L4), and polycaprolactone (L5). Branching agent Joncryl™ 4468 (B1) was added to the blend of PLA and flexible linker. Respective formulations for PLA resin samples BF1, BF2, and BF3 are outlined in table 1 below.

TABLE 1
PLA-Block Copolymer Formulations

| | Base PLA | | Flexible Linker | | | Branching Agent |
|---|---|---|---|---|---|---|
| Resin | P4 | P6 | L1 | L3 | L5 | B1 |
| Blend | wt % | wt % | wt % | wt % | wt % | wt % |
| BF1 | 0 | 98.9 | 1.0 | — | — | 0.1 |
| BF2 | 79.9 | — | — | 20 | — | 0.1 |
| BF3 | 79.9 | — | — | — | 20 | 0.1 |

### Example 2: Production of a Single Layer Biaxially Oriented PLA Using BF1

In this example, a single layer biaxially oriented PLA film was made with the reactively blended resin BF1. A cast film was produced from BF1 resin on a 1-meter-wide cast film line with a heating profile starting at about 160° C. and reaching about 180° C. at the die. The molten film was quenched on a chilled drum at about 25° C. with a thickness of about 400 μm. 4″ square sheets were cut from the cast film and then placed in a tenter frame for simultaneous biaxial stretching. The cast film was heated to about 75° C. under and oven and then tenter frame clips which clamped the film were pulled in a 4×4 ratio. A final film thickness of about 25 μm was obtained.

### Example 3: Production of a Single Layer Biaxially Oriented PLA Using BF2

In this example, a single layer biaxially oriented PLA film was manufactured using a process described in example 2, except resin BF2 was used. The L3 linker is PBAT, and includes grades such as Kingfa KB100 or Ecoflex C1200.

### Example 4: Production of a Single Layer Biaxially Oriented PLA Using BF3

In this example, a single layer biaxially oriented PLA film was manufactured using the process described in example 2, except blended resin BF3 was utilized instead of BF2.

### Example 5: Production of a Multilayer Biaxially Oriented PLA Using BF2

In this example, a coextruded multilayer PLA film was made using a twin-screw pilot line with sequential orientation processing with blended resin BF2 in all 3 layers. The L3 linker is PBAT, and includes grades such as Kingfa KB100 or Ecoflex C1200. The coextruded film was melted in the twin screw extruder with a temperature profile from about 70° C. to about 230° C. and cast onto a chill drum at about 15° C. with a thickness ranging from about 300 μm to about 400 μm. Machine direction orientation (MDO) stretching was immediately performed on the quenched cast film sample at preheating conditions from about 55° C. to about 65° C., and drawing temperatures from about 65° C. to about 25° C. Stretch ratios from about 3.5× to about 4.0× was achieved. Following MDO stretching, subsequent transverse direction orientation (TDO) stretching was performed in a tenter frame at processing temperatures from about 50° C. to about 120° C. Stretching ratios of about 3.0× to about 3.5× were achieved. Annealing of the film at high temperatures of about 120° C. was utilized to reduce final shrinkage of the film. A final film thickness of about 25 μm was achieved.

### Example 6: Production of a Multilayer Biaxially Oriented PLA Using BF3

In this example, a coextruded multiplayer PLA film was manufactured using a process similar to example 5 except PLA film was made with a reactively blended resin composed of BF3 instead of BF2.

### Example 7: Production of a Single Layer Biaxially Oriented PET

In this example, a single layer PLA film was made using a single screw biaxially oriented polyethylene terephthalate (BOPET) commercial line using blended resin BF2. The L3 linker is PBAT, and includes grades such as Kingfa KB100 or Ecoflex C1200. The coextruded film was melted in the single screw extruder with a temperature profile from about 70° C. to about 260° C. and cast onto a chill drum at about 25° C. with a thickness about 500 μm. MDO stretching was immediately performed on the quenched cast film sample at preheating conditions from about 55° C. to about 65° C., and drawing temperatures from about 65° C. to about 25° C. A 2.25× stretching ratio was achieved. Following MDO stretching, subsequent TDO stretching was performed in a tenter frame at processing temperatures from about 65° C. to about 120° C. A stretching ratio of 4.07× was achieved. Annealing of the film at high temperatures of about 120° C. was utilized to reduce final shrinkage of the film. A final film thickness of about 50 μm to about 70 μm was achieved. Mechanical properties obtained by various ASTM test standards are summarized in Table 2.

TABLE 2
Mechanical Properties of Biaxially Oriented Films

| | | Tensile | Tensile | | | Spencer | Tensile | Tensile | Dart |
|---|---|---|---|---|---|---|---|---|---|
| | | Strength | Strength | Elongation | Elongation | Impact | Modulus | Modulus | Impact |
| | Thickness | (MD) | (TD) | (MD) | (TD) | Strength | (MD) | (TD) | Strength |
| | (μm) | (MPa) | (MPa) | (%) | (%) | (MJ) | (MPa) | (MPa) | (g) |
| Example | | | | | | | | | |
| Example 2 | 20 | 175 ± 14 | 172 ± 25 | 58 ± 5 | 53 ± 6 | 2315 | 4149 ± 376 | 4081 ± 167 | — |
| Example 3 | 16 | 145 ± 9 | 118 ± 5 | 66 ± 8 | 45 ± 8 | 2214 | 3303 ± 130 | 3240 ± 322 | — |
| Example 4 | 22 | 117 ± 13 | 110 ± 12 | 79 ± 10 | 62 ± 11 | 2786 | 2601 ± 106 | 2661 ± 325 | — |
| Example 5 | 26 | 103 ± 13 | 132 ± 8 | 66 ± 10 | 50 ± 2 | — | 3132 ± 156 | 3549 ± 116 | 644 |
| Example 6 | 25 | 125 ± 15 | 102 ± 11 | 91 ± 13 | 46 ± 7 | — | 3148 ± 57 | 3028 ± 16 | 613 |
| Commercial | | | | | | | | | |
| Samples | | | | | | | | | |
| BOPET | 12 | 196 ± 12 | 263 ± 11 | 132 ± 13 | 96 ± 9 | — | 4573 ± 54 | 5562 ± 189 | 725 |
| CELLOPHANE | 22 | 158 ± 8 | 95 ± 3 | 13 ± 2 | 40 ± 6 | 47 | 7080 ± 322 | 3958 ± 113 | — |
| BOPE | 24 | 96 ± 3 | 88 ± 10 | 123 ± 5 | 109 ± 13 | — | 550 ± 36 | 554 ± 8 | — |
| BOPLA | 14 | 116 ± 12 | 99 ± 12 | 72 ± 6 | 78 ± 32 | — | 4322 ± 252 | 3725 ± 116 | — |
| BOPLA | 24 | 123 ± 3 | 126 ± 12 | 98 ± 4 | 87 ± 8 | — | 3899 ± 60 | 4440 ± 84 | — |
| BOPLA | 39 | 96 ± 6 | 115 ± 3 | 109 ± 10 | 94 ± 7 | — | 3963 ± 96 | 4485 ± 78 | — |

As seen in Table 2, BOPLA films as encompassed in Examples 5 and 6 exhibited tensile modulus of about 3132 MPa and 3148 MPa respectively, in the machine direction (MD), and about 3549 MPa and 3028 MPa respectively, in the transverse direction (TD), which are about 25% lower than tensile moduli (both MD and TD) of commercial BOPLA films without a flexible segment component while exhibiting comparable tensile strength in both MD and TD orientations to commercial BOPLA films. These results indicate that BOPLA films prepared from the blended resin of the present disclosure is less stiff, i.e., more flexible, while providing comparably robust (as measured by tensile strength) material not only compared to commercially available BOPLA films, but other alternative films also including cellophane, biaxially oriented polyethylene (BOPE). The lower modulus allows for better processability in the film production process, and in post-film production applications, as the lower modulus (˜3000 MPa) compared to neat PLA (˜4000 MPa) is not as stiff and brittle.

### Example 8

In this example, compostability/biodegradability between a traditional PLA resin, cellulose, and a biaxially oriented PLA produced from resin blend BF3 was tested with a modified AS 5810 standard at a temperature of about 28° C. for about 135 days. The disclosed films exhibited biodegradation at near room temperature around 28° C. while meeting industrial composting standards as defined by ASTM D6400, EN 13432, and ISO 17088.

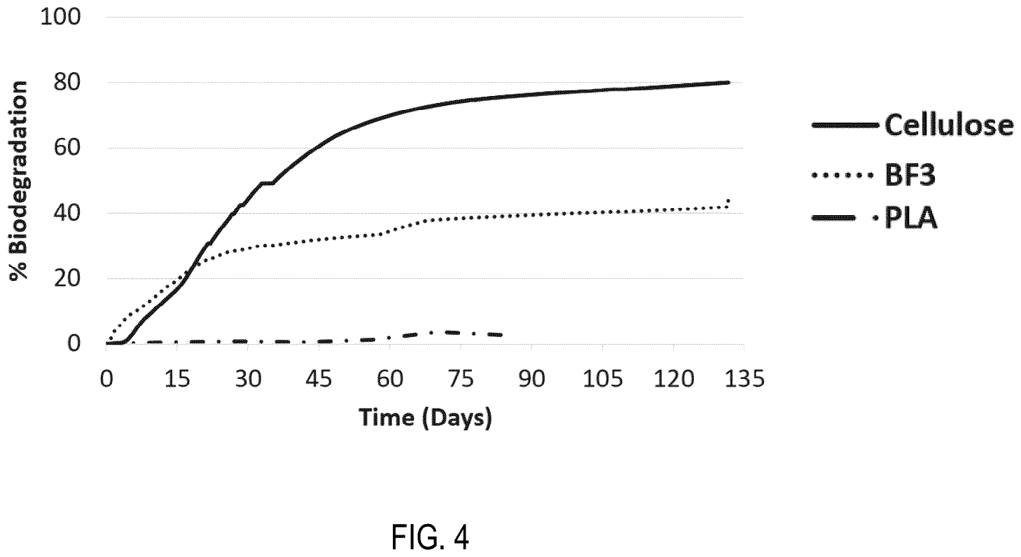

As shown in FIG. 4, BF3 resin of the present disclosure exhibited at least about 10% biodegradation in about 7 days, at least about 20% biodegradation in about 15 days, at least about 30% biodegradation in about 30 days, at least about 40% biodegradation in about 75 days. Biobased cellulose resin exhibited a comparable biodegradation rate up to about 20% in about 15 days, then more rapid biodegradation of about 30% in about 20 days, about 40% biodegradation in about 30 days, and over 75% biodegradation in about 75 days. In contrast, commercial PLA resin exhibited near 0% biodegradation even after 75 days under the same ambient condition. Accordingly, biaxially oriented articles, films, and laminates produced from polymer blend of the present disclosure present an opportunity for home composting conditions, as measured by AS 5810 standard solutions while maintaining advantageous mechanical properties, e.g., stiffness and flexibility of commercially available PLA.

The foregoing merely illustrates the principles of the disclosure. Any examples set forth in this specification are not intended to be limiting and merely set forth some of the many possible embodiments for the appended claims. Those skilled in the art will readily recognize various modifications and changes that may be made without following the example embodiments and applications illustrated and described herein, and without departing from the true spirit and scope of the following claims.

All references cited and/or discussed in this specification are incorporated herein by reference in their entirety and to the same extent as if each reference was individually incorporated by reference.

The features and functions described above, as well as alternatives, may be combined into many other different systems or applications. Various alternatives, modifications, variations or improvements may be made by those skilled in the art, each of which is also intended to be encompassed by the disclosed embodiments.

Without excluding further possible embodiments, certain example embodiments are summarized herein:

Embodiment 1: An extruded biaxially oriented film comprising: a PLA-homopolymer and a PLA-block copolymer blend, wherein the total wt % of polylactic acid in the film is 50-99%, wherein the total wt % a flexible segment in the film is 1-49%, wherein a PLA-block copolymer architecture comprised of polylactic acid and the flexible segment is present, and oriented films of the following composition exhibit markedly high tensile strength of from about 104 to 175 MPa as measured by ASTM D882, elongation from about 40 to 80% as measured by ASTM D882, and spencer impact strength of from about 2300 to 2800 MJ as measured by ASTM D3420, wherein the PLA polymers weight average molecular weights range, independently, from about 100,000 to about 200,000 g/mol, preferably from about 120,000 to about 180,000 g/mol, and desirably from about 140,000 to about 160,000 g/mol, and wherein the flexible segment is reacted to create an ABA or ABC triblock copolymer, wherein the A blocks are PLA polymers, the B blocks are flexible polymers, and the C blocks include compostable polyester polymers,

Embodiment 2: A film of embodiment 1, wherein the B block is selected from the group consisting of: linear polydimethylsiloxanes terminated with amines (PDMS-NH₂), linear polydimethylsiloxanes terminated with hydroxy units (PDMS-OH), linear polydimethylsiloxanes terminated with epoxides (PDMS-Epoxy) and any combination thereof with an inclusion of less than or equal to 1 wt %, wherein the weight average molecular weights of the polymers are between 10,000 and 140,000 g/mol, preferably between 30,000 and 110,000 g/mol, and desirably between 50,000 and 80,000 g/mol.

Embodiment 3: A film of embodiment 1, wherein the B block is selected from the group consisting of: polybutylene adipate terephthalate (PBAT), polycaprolactone (PCL), polyhydroxy alkanoates (PHAs), polybutylene succinate (PBS), polybutylene succinate adipate (PBSA), polybutylene sabacate (PBSeT) and any combination thereof with an inclusion of less than 50 wt. %, preferably less than 35 wt. %, and desirably less than 20 wt. %, wherein the weight average molecular weights of the polymers are between 80,000 and 600,000 g/mol, preferably between 100,000 and 450,000 g/mol, and desirably between 150,000 and 300,000 g/mol.

Embodiment 4: A film of embodiment 1, wherein the PLA-homopolymer includes a D-Lactide content of at most 6%, preferably less than 4%, and desirably less than 2%.

Embodiment 5: A film of embodiment 1, wherein the biaxially oriented film is a multilayer film, comprising a skin layer of a polylactic acid homopolymer of about 50-100 wt % L-lactic acid units, wherein weight average molecular weights range, independently, from about 100,000 to about 200,000 g/mol, preferably from about 120,000 to about 180,000 g/mol, and desirably from about 140,000 to about 160,000 g/mol.

Embodiment 6: A film of embodiment 1, wherein the biaxially oriented films' final thickness is a total thickness of between 10 and 200 μm, preferably between 15 and 100 μm, and desirably between 20 and 50 μm.

Embodiment 7: A film of embodiment 1, wherein the biaxially oriented film is metalized with deposition of aluminum onto the surface.

Embodiment 8: A method of making a block copolymer between a PLA polymer, and flexible linker in a continuous compounding process, for example a twin-screw extruder. The temperatures for the reactive extrusion process ranges from 140° C. to 220° C., preferably between 160° C. and 200° C., and desirably between 170° C. and 190° C.

Embodiment 9: A compound of embodiment 4, wherein a tin octanoate catalyst is included comprising from about 0.01 and 0.5 wt %, preferably from about 0.05 to 0.3 wt %, and desirably from about 0.1 to 0.2 wt %.

Embodiment 10: A compound of embodiment 4, wherein a compostable polyester is included comprising from about 1 wt. % to 80 wt. %, preferably from about 10 wt. % to 50 wt. %, and desirably from about 20 wt. % to 30 wt. %.

Embodiment 11: A method of making a biaxially oriented film; comprising an extrusion method to produce a cast film, with the subsequent stretching in the machine and transverse direction simultaneously or sequentially; wherein the oriented film comprises a PLA-homopolymer blended with PLA-block copolymer.

Embodiment 12: A method of embodiment 11, wherein the material has a moisture level less than 1000 ppm, preferably less than 100 ppm, and desirably less than 50 ppm.

Embodiment 13: A method of claim 11, wherein the melt curtain of the polymer is quenched onto a chilled roll having a temperature between −20° C. and 50° C., preferably between 0° C. and 40° C., and desirably between 15° C. and 25° C.

Embodiment 14: A method of embodiment 11, wherein the cast film is oriented in the machine direction at a rate from about 2.0-4.0×, preferably from about 3.0-3.5×.

Embodiment 15: A method of embodiment 11, wherein the cast film is oriented in the transverse direction at a rate from about 2.0-5.0×, preferably from about 3.5-4.0×.

1. A biodegradable polymer film comprising one or more layers, wherein at least one layer is a composition comprising:
a polylactic acid (PLA)-block copolymer blend comprising a PLA segment and a flexible polymer segment, wherein the PLA segment comprises about 50 wt % to about 99 wt % PLA, based on the total weight of the PLA-block copolymer blend,
wherein the biodegradable polymer film is biaxially stretched, and
wherein the biodegradable polymer film exhibits an average Dart impact strength of about 450 g to about 700 g, an average tensile modulus of about 2500 MPa to about 4500 MPa along a machine direction or a transverse direction, and/or an average biodegradation of at least 40% biodegradation within about 75 days at a temperature in a range of about 25° C. to about 30° C.

2. The biodegradable polymer film of claim 1, wherein the PLA-block copolymer blend is in the form of an A-B-A triblock copolymer, wherein A is the PLA segment and B is the flexible polymer segment.

3. The biodegradable polymer film of claim 1, wherein the PLA-block copolymer blend further comprises a compostable polyester segment.

4. The biodegradable polymer film of claim 3, wherein the PLA-block copolymer blend is an A-B-C triblock copolymer, wherein A is the PLA segment and B is the flexible polymer segment, and C is the compostable polyester segment.

5. The biodegradable polymer film of claim 3, wherein the compostable polyester segment is selected from polybutylene adipate terephthalate (PBAT), polycaprolactone (PCL), polyhydroxy alkanoates (PHAs), polybutylene succinate (PBS), polybutylene succinate adipate (PBSA), polybutylene sebacate (PBSe), and polybutylene sebacate terephthalate (PBSeT).

6. The biodegradable polymer film of claim 3, wherein the PLA-block copolymer blend comprises from about 0 wt % to about 80 wt % compostable polyester segment, based on the total weight of the PLA-block copolymer blend.

7. The biodegradable polymer film of claim 1, comprising from about 0 wt % to about 50 wt % flexible polymer segment, based on the total weight of the PLA-block copolymer blend.

8. The biodegradable polymer film of claim 1, wherein the flexible polymer segment is selected from polybutylene adipate terephthalate (PBAT), polycaprolactone (PCL), polyhydroxy alkanoates (PHAs), polybutylene succinate (PBS), polybutylene succinate adipate (PBSA), polybutylene sebacate (PBSe), polybutylene sebacate terephthalate (PBSeT), polyethylene glycol (PEG), and linear polydimethylsiloxane (PDMS).

9. The biodegradable polymer film of claim 8, wherein the linear polydimethylsiloxane has two ends, each end terminated with a group selected from an amine (NH₂), a hydroxyl (OH), and an epoxide.

10. The biodegradable polymer film of claim 8, wherein the flexible polymer segment has a weight average molecular weight in a range of about 2,000 g/mol to about 600,000 g/mol.

11. The biodegradable polymer film of claim 1, further comprising a PLA skin layer on a top surface and/or a bottom surface of the biodegradable polymer film, wherein the PLA skin layer comprises PLA homopolymer.

12. (canceled)

13. The biodegradable polymer film of claim 11, wherein the PLA skin layer comprises a L-lactide content of about 50 wt % to about 88 wt %, based on the total weight of the PLA homopolymer.

14. The biodegradable polymer film of claim 1, wherein total thickness of the biodegradable polymer film is in a range of about 10 μm to about 100 μm.

15. The biodegradable polymer film of claim 1, wherein the at least one layer is a core layer and the biodegradable polymer film further comprises:
a PLA skin layer positioned on a top surface of the core layer, wherein the PLA skin layer comprises PLA homopolymer, and the PLA skin layer comprises about 50 wt % to about 88 wt % L-lactide content, based on the total weight of the PLA homopolymer,
wherein the PLA homopolymer has a weight average molecular weight in a range of about 100,000 g/mol to about 200,000 g/mol.

16. The biodegradable polymer film of claim 15, wherein the PLA skin layer is a first PLA skin layer comprising a first PLA homopolymer, and the biodegradable polymer film further comprises a second PLA skin layer positioned on a bottom surface of the core layer;
wherein the second PLA skin layer comprises a second PLA homopolymer, and the second PLA skin layer comprises about 50 wt % to about 88 wt % L-Lactide content, based on the total weight of the second PLA homopolymer, and
wherein the second PLA homopolymer has a weight average molecular weight in a range of about 100,000 g/mol to about 200,000 g/mol.

17. An article produced from the biodegradable polymer film of claim 1.

18. A method of producing a biodegradable polymer film, comprising the steps of:
(a) melt extruding a PLA polymer and a flexible linker in the presence of a catalyst to produce a PLA-block copolymer composition comprising about 1 wt % to about 49 wt % flexible linker, based on the total weight of the PLA-block copolymer composition;
(b) quenching the PLA-block copolymer composition on a chilled roller; and
(c) stretching the PLA-block copolymer composition along a machine direction (MD) and a transverse direction (TD) to produce the biodegradable polymer film;
wherein the biodegradable polymer film has an average Dart impact strength of about 450 g to about 700 g, an average tensile modulus of about 2500 MPa to about 4500 MPa along a machine direction or a transverse direction, and/or an average compostability of at least 40% biodegradation within about 75 days under composting conditions at a temperature in a range of about 25° C. to about 30° C.

19. The method of claim 18, wherein step (a) is carried out at a temperature in a range of about 170° C. to about 220° C.

20. The method of claim 18, wherein the catalyst comprises tin octanoate and step (a) further comprises adding about 0.01 wt % to about 0.5 wt % of tin octanoate catalyst, based on the total weight of the PLA-block copolymer composition.

21. The method of claim 18, wherein step (b) is carried out at a temperature in a range of about −20° C. to about 30° C.

22. The method of claim 18, wherein the stretching along the machine direction in step (c) is carried out at a temperature in a range of about 40° C. to about 65° C.

23. The method of claim 18, wherein the stretching along the transverse direction in step (c) is carried out at a temperature in a range of about 85° C. to about 105° C.

24. The method of claim 18, wherein the PLA-block copolymer composition is stretched along the machine direction at a machine orientation ratio of about 2.0× to about 4.0×.

25. The method of claim 18, wherein the PLA-block copolymer composition is stretched along the transverse direction at a transverse orientation ratio of about 2.0× to about 5.0×.

26. The method of claim 18, wherein step (a) further comprises adding about 1 wt % to about 80 wt % compostable polyester, based on the total weight of the PLA-block copolymer composition.
